(19) United States
(12) Patent Application Publication
(10) Pub. No.: US 2004/0059952 A1
(43) Pub. Date: Mar. 25, 2004

(54) Authentication system

(76) Inventors: Peter Newport, London (GB); Jian Azari, London (GB)

Correspondence Address: BUCKLEY, MASCHOFF, TALWALKAR LLC, 5 ELM STREET, NEW CANAAN, CT, 06840, US

(21) Appl. No.: 10/450,755

(22) PCT Filed: Dec. 13, 2001
(86) PCT No.: PCT/GB01/05507

(30) Foreign Application Priority Data
Dec. 14, 2000 (GB) 0030542.5
Mar. 8, 2001 (GB) 0105728.0

(51) Int. Cl. H04L 9/32

(52) U.S. Cl. 713/202

(57) ABSTRACT

The present invention allows clients to authenticate consumers using a trusted authentication service provider. The system addresses the concerns of consumers and business organisations alike. The objective is to assure clients of the authentication service of the true identity of the consumer. The remote authentication service provider maintains consumer data to facilitate a fast authentication of the consumer on the basis of a consumer name and a unique consumer code. In a preferred system, the unique consumer code is a one-time password (OTP) generated by a hardware token held by the consumer. The remote authentication service provider confirms that any password generated by the token is valid.

### FIELD OF THE INVENTION

The present invention relates to a system for authenticating a user to an entity for the purpose of conducting transactions or to access services or resources.

### BACKGROUND TO THE INVENTION

Authentication is the process of verifying the identity of users or other entities, for example processes or external systems, prior to granting access to a requested resource. This is usually based on a username and a password. Static passwords remain the most widely used authentication mechanism, but are recognised as a security hazard. In particular, static passwords are vulnerable to recording, sharing, “sniffing” (where passwords are captured as they are transmitted), and “shoulder surfing” (where users are observed using their passwords). They are also susceptible to “re-play” attacks. A relatively new approach to this problem is the use of one-time passwords (OTPs). These are similar to traditional static passwords in that they are used in conjunction with a username, but are instead generated dynamically using a hardware token.

Financial transactions can be performed in a vast number of ways. Thus, as well as being able to pay for goods and services using cash, credit card and debit card payments are also possible. In addition to this, it is possible to arrange a direct money transfer between bank accounts in order to make payments.

The techniques by which these transactions may be completed vary depending on the circumstances in which the transaction is performed. For example, in a shop it is typical for the customer to present their payment card to the shop assistant. Th shop assistant then enters these details into a point of sale (POS) device which transfers the details to an acquirer (the financial institution, or its agent, that acquires from the merchant financial data relating to a transaction and initiates that data into an interchange system), which confirms whether the payment card may be used to perform the desired transaction. The shop assistant confirms that the payment card has been presented by an authorized user by checking the customer's signature against the signature on the back of the card. Assuming that each of these stages proceeds successfully, then the transaction is authorised. In this cas , the acquirer or issuer (the financial institution, or its agent, that issues the unique primary account number (PAN) to the cardholder for the payment card brand) covers the shop's bill for the purchased goods, with the card owner being debited at a lat r date.

However, this form of system suffers from the major drawback that the payment card must be made available to the shop assistant. This provides the opportunity for third parties to obtain the card details and then use these details to fraudulently perform transactions. In particular, this can be achieved by producing counterfeit payment cards, or alternatively by simply using the card details directly to make “cardholder not present” purchases.

In recent times, the situation has been exacerbated by the introduction of Internet shopping which allows consumers to buy items from a web site. In this example, the users payment card details typically have to be transferred via the Internet to the web site to allow the web site owner to validate the transaction. This of course again means that the customers card details are available to the public thereby risking fraudulent transactions to be carried out with these details. Furthermore, there is no form of authentication in this transaction since the cardholder is not present.

Traditional banks and branchless institutions are flooding the home and business banking market with a wave of services delivered via the Internet Companies are evaluating Internet banking as a way to decrease costs and increase efficiency. Banks have begun to offer advanced Internet banking services which include access to account and fund information, bill payments, transfers between accounts at the same institution, mortgage information, and access to the latest transactions and other historical information on selected accounts. Internet banking provides a new channel through which banks can offer even more advanced transaction services such as stock trading, signing shopping transactions, or electronically transferring any amount to any account at any financial institution. However, the fear of exposing confidential financial information remains a major obstacle to widespread implementation and use of on-line banking. Banks need to be sure customers accessing their accounts on-line are who they say they are i.e. that they are authenticated. Furthermore, customers want to know that personal information, account numbers and funds are secure. Current systems still tend to rely on a static password based authentication system and are therefore inherently susceptible to attack. This remains a major concern that needs to be addressed before Internet banking will secure the confidence of consumers.

### SUMMARY OF THE INV NTION

According to a first aspect of the present invention, an authentication service for authenticating a consumer to a client using a remote authentication service provider that is adapted to respond to authentication requests from a plurality of different clients, in which the authentication service provider carries out the steps of:

receiving an authentication request, the authentication request including a consumer name and a unique consumer code;

accessing at least one authentication data store containing consumer data associated with the consumer name;

determining the validity of the unique consumer code in dependence on the consumer data; and,

transmitting an authentication reply to the client confirming whether or not the consumer has been authenticated.

According to a second aspect of the present invention, a computer program product comprises computer executable code for performing the method of the first aspect of the present invention.

In this application, the term “consumer” will refer to end-users seeking to authenticate themselves for the purposes of conducting transactions or to access services and resources. The term “client” refers to organisations that subscribe to the remote authentication service. These may include retailers (merchants), Internet banks, or any business organisation offering controlled access to services or resources.

According to a third aspect of the present invention, an authentication engin for providing a remote authentication service for a plurality of different clients requiring authentication of consumers prior to completing a transaction or granting access to a service or application provided by the client, the authentication engine comprising:

a communications interface for accepting an authentication request from a client, the authentication request including a consumer name and a unique consumer code;

at least one authentication data store containing consumer data associated with the consumer name; and,

a processing system adapted for accessing the at least one authentication data store and determining the validity of the unique personal cod in dependence on the consumer data, and for generating an authentication reply to the client confirming whether or not the consumer has been authenticated.

According to a fourth aspect of the present invention, a method of authentication in which a consumer requests a transaction or access to a service or resource provided by a client, in which the client carries out the steps of:

obtaining a consumer name and a unique consumer code from the consumer;

transmitting an authentication request to a remote authentication service provider that is accessible by a number of different clients, the authentication request including the consumer name and the unique consumer code;

receiving an authentication reply from the remote authentication service provider identifying whether or not the consumer has been authenticated; and,

if the consumer is authenticated, proceeding with the transaction or providing the access or service requested by the consumer.

The present invention allows clients to authenticate consumers using a trusted authentication service provider. The system addresses the concerns of consumers and business organisations alike. The objective is to assure clients of the authentication service of the true identity of the consumer. The remote authentication service provider maintains consumer data to facilitate a fast authentication of the consumer on the basis of a consumer name and a unique consumer code.

In a preferred system, the unique consumer code is a one-time passwords (OTP) generated by a hardware token held by the consumer. The remote authentication service provider confirms that any password generated by the token is valid. The consumer name need not be the real name of the consumer, but it must correspond to the consumer name stored by the remote authentication service provider. Accordingly, if desired, the consumer can maintain their anonymity. Furthermore, the authentication reply may include a preferred “friendly name” that the consumer wishes to be addressed by.

The system is especially suitable for Internet applications where a business needs to authenticate an end-user before it will grant access to a particular service or application. In particular, the system can be used in Internet banking applications where the bank requires authentication of the customer before granting access to the web site. In the present invention, the bank provides a logon page displayed by the customer's browser having a window in which the customer can type in a userID and a password generated by their personal token. The bank then transmits this information to the remote authentication service provider in a secure manner in the form of an authentication request. The remote authentication service provider generates an authentication response in the form of a simple pass or fail result If the customer is authenticated then access to the web site is granted in the normal manner.

A consumer may have a number of Internet bank accounts with different banks. Provided the banks are clients of the remote authentication service provider, the user need only maintain a single hardware token for generating passwords.

According to a fifth aspect of the present invention, a payment authorisation service in which a client transmits a payment authorisation request in respect of a consumer transaction to a remote service provider adapted to respond to payment authorisation requests from a number of different clients, in which the remote service provider carries out the steps of:

receiving a payment authorisation request from a client, the payment authorisation request including a consumer and a unique consumer code;

accessing at least one data store containing consumer data associated with the consumer name and determining the validity of the unique consumer code in dependence on the consumer data, thereby authenticating the consumer; and, executing a payment process to fulfil the payment authorisation request and thereby complete an authorised transaction.

According to a sixth aspect of the present invention, a computer program product comprises computer executable code for performing the method of the fifth aspect of the present invention.

According to a seventh aspect of the present invention, a payment authorisation engine for providing a hosted remote payment authorisation service for a plurality of different clients transacting with consumers, the payment authorisation engine comprising:

a communications interface for receiving a payment authorisation request from a client, the payment authorisation request including a consumer name and a uniqu consumer code;

a number of data stores containing consumer data, including details of consumer payment cards; and

a processing syst m including a number of payment modules that enable authorised payments according to a predetermined protocol, the processing system being adapted for accessing at least one data stor containing consumer data associat d with the consumer name and determining the validity of the uniqu consum r code, thereby authenticating the consumer, and ex cute a payment process using a selected payment module to fulfil the payment authorisation request and thereby complete an authorised transaction.

The present invention also provides an extension of the remote authentication service in which the remote authentication service provider also maintains a database containing details of consumer's payment cards. The system is designed to facilitate and enable secure commercial transactions by consumers using credit or debit payments by avoiding the need to present the card or card details to a merchant, whether locally (at a POS device), over a telephone, or to a web site over the Internet.

The manner in which payment authorisation is obtained is dependent on the payment protocol stipulated by the acquirer and/or issuer. Accordingly, the present invention supports many different payment protocols through a number of different payment modules. The modularity of the architecture permits the addition of new payment services in a discrete manner.

One example of a payment module is a hosted merchant POS, in which th payment authorisation request includes a consumer name, a unique consumer code, a transaction amount and a selected method of payment. The service provider transmits a payment authorisation request to an acquirer associated with the selected method of payment to obtain a transaction identifier and subsequently transmits an authorisation reply to the client, the authorisation reply including the transaction identifier provided by the acquirer.

In a preferred system, the service provider maintains a “Vault” that contains data associated with respective consumer names to allow a consumer to b authenticated. The service provider also maintains a “Registry” that contains the credit and debit card details associated with the consumer. When a client of the servic provider requests an authorised payment, the service provider first authenticates the consumer using the consumer name and an OTP forwarded by the client and then generates an authorisation request for transmission to an acquirer. The authorisation request typically includes the customer name, the primary account number (PAN) associated with the selected method of payment, the transaction amount, and a merchant identifier. The acquirer returns a transaction identifier and a transaction authorisation code that guarantees non-repudiation of the transaction. Thus, the service provider effectively acts to host a remote POS. In som cases, the acquirer may have to communicate with the card issuer to obtain proper authorisation.

The Secure Electronic Transaction (SET) protocol is another payment service that can be offered through the present invention, in which the system hosts a consumer SET wallet payment module that engages in the SET exchange on behalf of consumers. The proposed solution hosts all of the necessary SET software and cryptographic data (digital certificates, cryptographic keys) within the Registry's database and a SET payment module. This approach eliminates the need for consumers to install the SET client software on their computing platforms and enables greatly enhanced mobility by allowing consumers to make purchases through any channel (eg Internet, WAP, telephone) without the need to transport and install the SET software and digital certificates. Again, the preferred system secures access to the SET wallet using consumer name and an OTP.

### BRIEF DESCRIPTION OF THE DRAWINGS

Examples of the present invention will now be described in detail with reference to the accompanying drawings, in which:

FIG. 1 is an example of a token-based authentication system in accordance with the present invention;

FIG. 2 is a simplified schematic of a consumer token;

FIG. 3 is an example of a token-based authentication and payment system in accordance with the present invention;

FIG. 4 illustrates a SET transaction using the system shown in FIG. 3; and,

FIG. 5 shows the sequence of events in a SET transaction.

### DETAILED DESCRIPTION

As mentioned above, in this application, the term “consumer” refers to end-users seeking to authenticate themselves for the purposes of conducting transactions or to access services and resources. The term “client” refers to organisations that subscribe to a remote authentication service provider (ASP). These may include retailers (merchants), Internet banks, or any business organisation offering controlled access to services or resources.

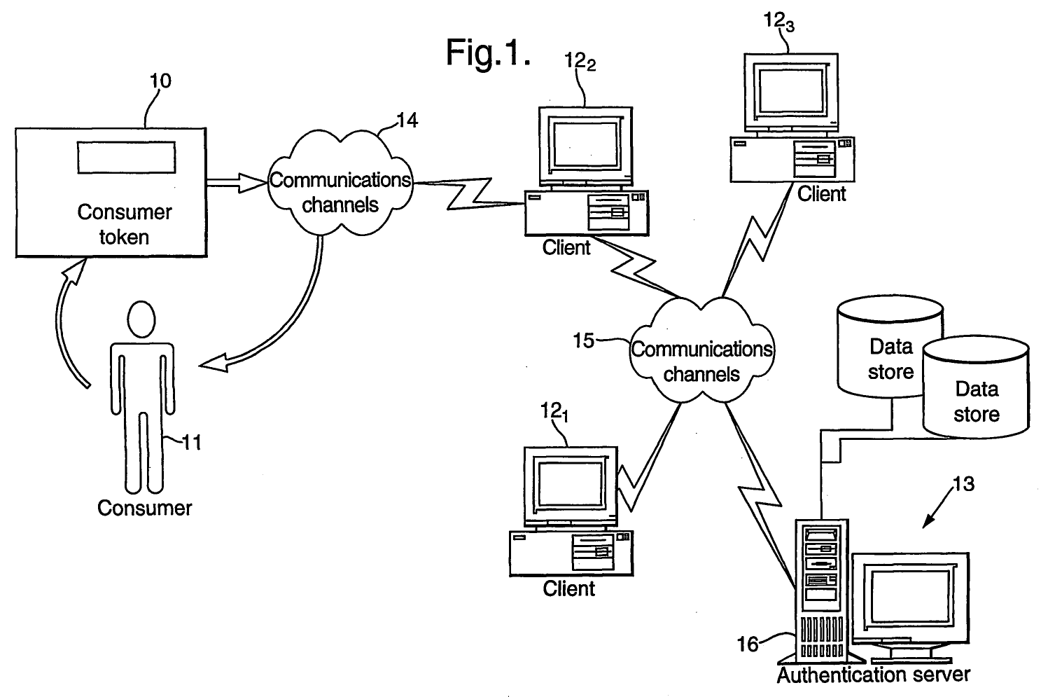

FIG. 1 illustrates an example of a token-based authentication system in accordance with the present invention. The system includes a consumer hardware token 10 of a type that is generally known in the art for generating one-time passwords (OTP). A password is generated by the token each time the consumer 11 keys in a PIN or other form of secret code. The consumer presents a consumer name and a password generated by the token to one of a number of clients 12 of a remote authentication service provider 13 (ASP). A number of communications channels 14 are contemplated. For example, the consumer may simply provide the authentication data in person to the client 12 or it may be provided over the Internet by filling out a form presented as a window displayed by the consumer's browser.

The client 12 communicates with the ASP 13 over a secure communications channel 15, for example an Internet-VPN an encrypted leased line, an SSL (Secure Socket Layer) connection or any other encrypted channel, for the transmission of an authentication request which includes the authentication data provided by the consumer and for receiving an authentication reply generated by the ASP 13. The ASP operates one or more authentication servers 16 that maintains a number of data stores that contain consumer data associated with respective consumer names to facilitate a rapid authentication of a consumer on the basis of the authentication data provided by the client 12. The consumer name used by the consumer need not be their real name so that they can maintain their anonymity should they desire. The.

ASP 13 verifies whether or not the password provided by the consumer 11 is valid by independently computing a password that should be the same. If successful, the ASP 13 generates an authentication reply and transmits this to the client 12, thereby authenticating the consumer to the client.

The system is especially suitable for Internet applications where the client may be a business that needs to authenticate an end-user before it will grant access to a particular service or application. In particular, the system can be used in Intern t banking applications where a bank requires authentication of a customer before granting access to the web site. In the present invention, the bank provides a logon page displayed by the customer's browser having a window in which the customer can type in a userID and a password generated by their personal token. The bank then transmits this information to the ASP in a secure manner in the form of an authentication request. The ASP generates an authentication response in the form of a simple pass or fail result. If the customer is authenticated then access to th web site is granted in the normal manner.

A consumer may have a number of Internet bank accounts with diff rent banks. Provided the banks are clients of the remote authentication service provider, the user need only maintain a single hardware token for generating passwords.

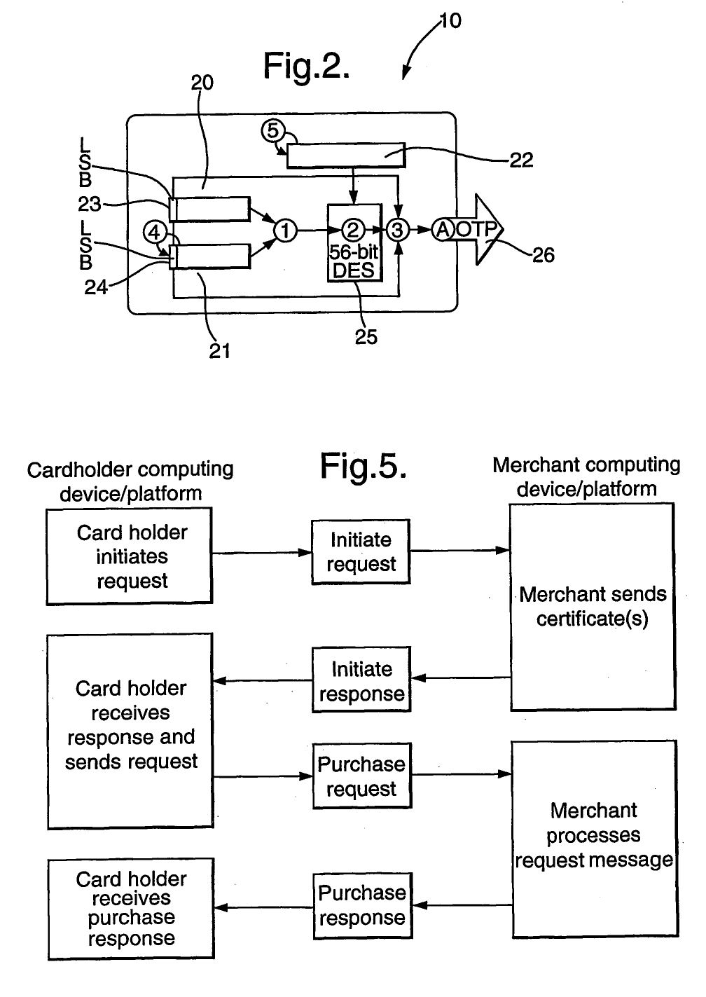

FIG. 2 shows schematically an example of a consumer token 10.

The authentication process described above relies on a synchronous authentication mode whereby the consumer token 10 and the authentication server 16 perform a series of tasks using the same variables (a clock counter 20 and event counter 21) which are then encrypted using a shared secret 22 to generate a six digit challenge. It is common for the clocks provided on the token and at the authentication server to drift over time. To compensate for this phenomenon and to ensure a reliable service, the password generated by the token which is sent to the authentication server includes two digits prefixed to the challenge. These digits are the least significant bits 23 and 24 from the token's clock and event counters, respectively, which are used by the authentication server 16 to synchronise itself to the token.

The customer token 10 performs the following steps:

1. The token builds an internal challenge (independently of the authentication server) using two variables, the token clock counter value 20 and the token event counter value 21;

2. The token encrypts this internal challenge with a 56-bit DES algorithm 25 using a third variable, a derived secret key that is unique to that specific token and is used only for that specific encryption session to create an OTP;

3. The token selects the two least significant bits (one each from the event and clock counters) and prefixes them to an encrypted result. This result 26 is sent to the authentication server 16 during the authentication request process;

4. The token increments its event counter 21 by one; and,

5. The token derives a new secret key 22, which overwrites the secret used in the previous encryption session. The key derivation process is based on the ANSI X9.24 standard. It uses the event counter and the previous secret key to generate a new key for the next session.

As described above, the next series of tasks is performed by the authentication server 16, which authenticates the consumer based upon a password match. Since the authentication server must perform exactly the same calculations with the same three variables to compare meaningful results at the end of the session, the sever variabl s must be synchronised with the client variables at all times. As described above, this is achieved using the two special digits prefixed to the value generated by the 56-bit DES encryption process. The authentication server 16 compares the two digits and determines if the token digits match those stored at the server. If required, the authentication server re-synchronises its event and clock counters to match thos of the token (within defined security parameters) and then iterates through the key derivation process until it derives the necessary key that corresponds to the key used by the token. When the server has determined that its digits are re-synchronised, it builds its own internal challenge using its clock and event counter values, encrypts that challenge using the appropriate key and the 56-bit DES algorithm, and compares the consumer's and the server's encrypted challenges to determine if the authentication was successful. Only when the match is successful does the server increment its event counter by one and derive a new secret key for that consumer. The new secret key is stored as part of a secure data block (SDB) within a database.

The authentication server 16 performs the necessary validation using the sam algorithms and values as the token. Each token 10 has unique initialisation values that are set at the token initialisation stage. These initial values are stored encrypted in a data file (not shown) used by the authentication server 16 and consist of the initial 56-bit DES secret key, a 32-bit random event counter, the token serial number, and the profile for the token. Each entry is stored as an SDB. Decryption of the SDB is handled by a computer program that is supplied with the 56-bit DES secret key for that SDB.

The present invention also provides an extension of the remote authentication service described above in which the ASP maintains a database containing details of consumer's payment cards. As will be described below, the system is designed to facilitate and enable secure commercial transactions by consumers using credit or debit payments by avoiding the need to present the card or card details to a merchant, whether locally (at a POS device) or to a web site over the Internet

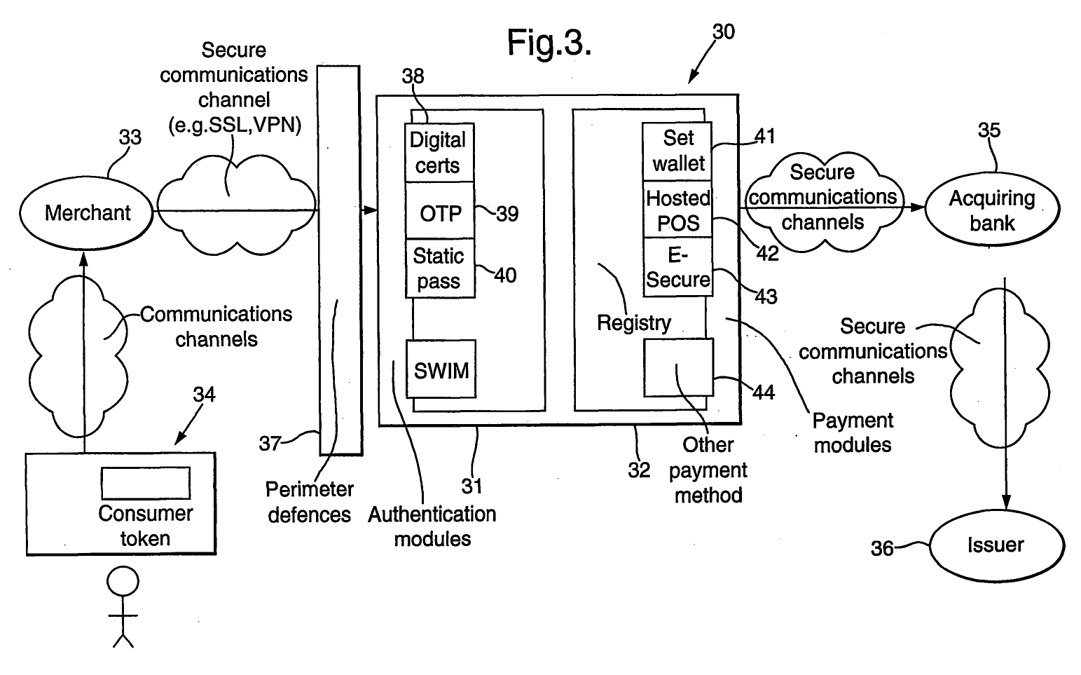

As shown in FIG. 3, the ASP 30 maintains a “Vault” 31, an authentication server that allows a consumer to be authenticated in the manner described in detail above. The service provider also maintains a “Registry” 32 for facilitating authorised payments.

At a high level, the communications between the parties can be summarised as follows: when a client 33 of the service provider 30, for example a merchant, requests an authorised payment, the service provider 30 first authenticates the consumer 34 using the Vault 31 on the basis of the consumer name and OTP forwarded by the merchant 33 and then generates an authorisation request for transmission to an acquiring bank 35. The authorisation request typically includes the customer name, the primary account number (PAN) associated with the selected method of payment, the transaction amount, and a merchant identifier. The acquirer 35 returns a transaction identifier and authorisation code that guarantees non-repudiation of the transaction. Thus, the service provider 30 effectively acts to host a remote POS. In some cases, the acquirer may have to communicate with the card issuer 36 to obtain proper authorisation.

The manner in which the ASP 30 obtains a transaction authorisation is dependent on the payment protocol stipulated by the acquirer and/or issuer. Accordingly, the present invention supports many different payment protocols.

The server architecture shown in FIG. 3 can be broken down into four key components and their interactions:

1. Authentication system 31 (the Vault);

2. Payment system 32 (the Registry);

3. Database of consumer profiles (not shown); and,

4. Audit and data logging component (not shown).

In this example, the primary platforms hosting the service are Hewlett-Packard HP9000L and N class HP-UX servers. Applications include Oracle database, iPlanet Web Server, a stateless authentication kernel, and bespoke software to link the components. Perimeter defences 37 include firewall technology, intrusion detection systems and the hosting of the servers on HP Virtual Vaults.

The authentication system implemented in the architecture in FIG. 3 is as described above with reference to FIGS. 1 and 2. However, the system can support various authentication mechanisms including digital certificates 38, but the OTP hardware token mechanism 39 described above is preferred. In addition, static passwords 40 may be used as a temporary fall-back authentication.

The payment system 32 consists of a number of payment service modules each capable of transacting using existing payment protocols 41 to 44. These can be SET transactions 41, POS transactions 42 or any other acceptable payment protocol. The modular design enables the addition of new payment modules as required.

The payment system 32 effectively proxies payment transactions on behalf of the merchant using the consumers profiles and associated payment card details obtained out-of-band during the consumers subscription and initialisation stage (in which the token is also shipped to the consumer) and stored within the Registry database. In the case of credit cards, the system provides security and a degree of anonymity to the consumer by transacting directly with the acquiring banks thereby obviating the need to transmit personal payment card details to merchants.

Interactions' during the payment transaction are limited to the ASP 30, the merchant 33 and the acquiring bank 35. This requires merchants to enable their web sites with an ASP payment option. Once enabled, the merchants web site transmits a purchase request including the following details:

1. Consumer name;

2. OTP;

3. Transaction amount;

4. Merchant ID;

5. Acquiring bank's ID;

6. PAN; and,

7. Payment method.

Successful authentication within the ASP Vault 31 is then followed by-a payment transaction with the ASP Registry 32 using the consumers details and the supplied merchant details. The Registry 32 communicates with the acquiring bank using the appropriate payment and communications protocol associated with one of the payment modules 41 to 44. Credit card transactions will result in the Registry 32 supplying a transaction code along with the purchase amount and Merchant ID and any other data required to complete the payment. Upon successful complection, th Registry 32 returns an authorisation code to the merchant 33 for their records.

The system relies on three databases (not shown): one for the authentication server for token details and keys (SDB); a separate database for the Registry to host consumer details for payment transactions; and a third database for customer relationship management. The databases provide large amounts of storage capacity and performance which can be scaled as necessary.

Every consumer is initialised within the system and defined within a user profile. These profiles include the necessary data for authenticating and subsequently completing payment transactions on behalf of the authenticated consumers. Token initialisation data and token serial numbers, user names and other authentication data is stored in one database that is accessed by the Vault.

Consumer details such as credit card details are the most obvious data associated with the consumer. However, there may be a need to store SET certificates for SET-based payments as well as additional details such as shipping addresses to facilitate the purchase by automatically supplying the necessary details for suppliers or merchants to ship the goods to consumers. This information is stored in a database that is accessed by the Registry.

The importance of and enforcement of non-repudiation requires a high degree of security, auditing and logging capabilities. To this end, the architecture has been designed with perimeter defences 37, logical and physical access controls and plans to configure and enable extensive monitoring and logging services. Every authentication and transaction request along with the results are logged on Write Once Read Many (WORM) media (not shown) to ensure that the data cannot b altered following the recording of the log entry.

The type of audit data includes the consumer, merchant and acquiring bank requests, replies and time stamps.

The Secure Electronic Transaction (SET) protocol is a payment service that can be offered, in which the system hosts a consumer SET wallet payment module that will engage in a SET exchange on behalf of consumers. The system hosts all of the necessary SET software and cryptographic data (digital certificates, cryptographic keys) within the Registry's database and a SET payment module. This approach eliminates the need for consumers to install the SET client software on their computing platforms and offers greatly enhanced mobility by allowing consumers to make purchases through any channel (eg Internet, WAP, telephone) without the need to transport and install the SET software and digital certificates.

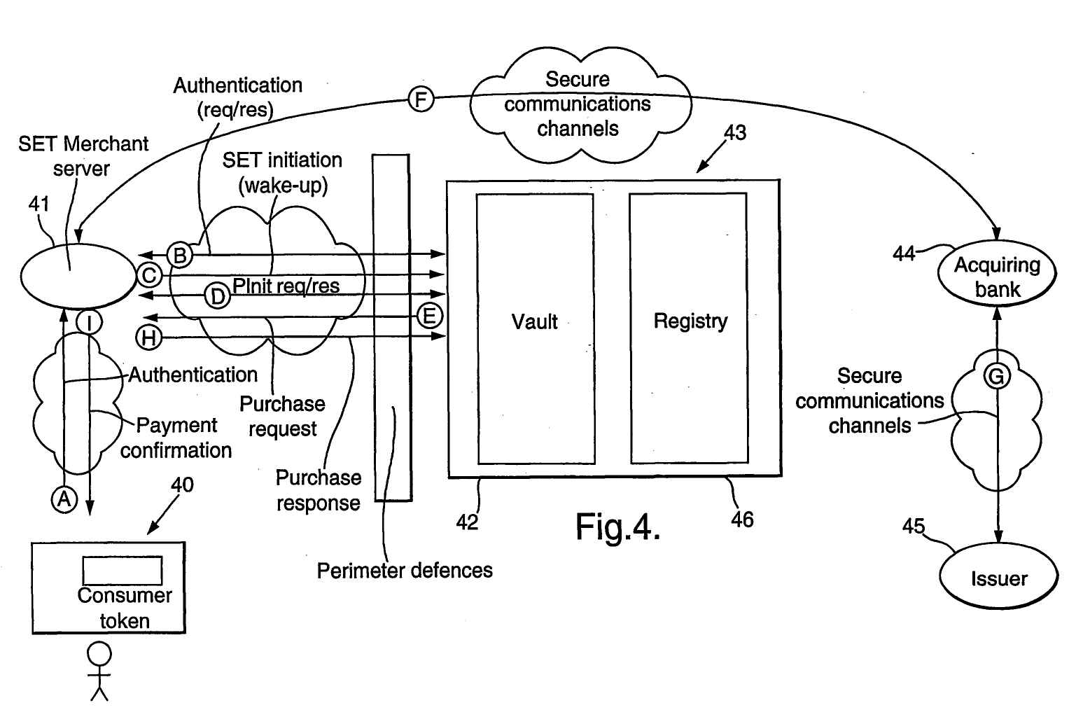

FIG. 4 illustrates generally how the architecture operates in a SET transaction. The steps are as follows:

(A) The consumer 40 uses a standard browser with no additional software, and without a smartcard reader, to browse to a merchant site 41. The consumer fills up their shopping basket and proceeds to a payment pag. On this page th consumer chooses to pay using the ASP option. The consumer is prompted for their consumer name and pass code.

(B) The consumer name and password are forwarded by the merchant 41 to the Vault 42 of the remote ASP 43 which authenticates the consumer as described above, and the result (status) is sent back to the merchant

(C) As part of a successful authentication of the consumer 40, the merchant 41 initiates a SET transaction with the consumer's hosted SET wallet at the ASP Registry 46 and supplies the necessary Order Information (OI).

(D) A purchase initialisation request and response is exchanged between the merchant and the remote ASP 43 hosting the consumer's SET wallet

(E) A purchase request is sent from the ASP 43 (on behalf of the consumer)-to the merchant 41.

(F) The merchant now requires authorisation from their acquirer 44. This optional exchange occurs between the merchant 41 and its acquirer 44 as per a normal credit card transaction, using standard SET protocol exchange as defined by SetCo for merchant-acquirer exchanges.

(G) The acquirer has the option of referring to the card issuer 45 in order to obtain authorisation. This optional exchange occurs between the acquirer 44 and the card issuer 45 as per a normal credit card transaction, using standard SET protocol exchange as defined by SetCo for merchant-acquirer exchanges.

(H) The merchant 41 returns a purchase response to the hosted SET-wallet at the ASP 43.

(I) The merchant 41 returns a confirmation of the payment to th consumer 40.

In FIG. 4, the merchant 41 connects directly to the acquirer 44 instead of using the ASP Registry 46 to obtain transaction authorisation. This is in order to ke p the merchant as close as possible to ordinary SET. If desired, the merchant could let the ASP 43 host the POS part of its functionality which would connect to the payment gateway for authorisation.

The authentication steps from the consumer 40 via the merchant 41 to the Vault 42 and back to the merchant is exactly the same as in any other card transaction. We will describe in detail below with reference to FIGS. 4 and 5 what happens after the merchant 41 gets a positive answer back confirming that the cardholder has been properly authenticated.

The purpose of the Initiate message (PInitReq) from the cardholder to the merchant and the Initiate response (PInitRes) from the merchant to the cardholder is to obtain certificates and CRLs for the Cardholder. In the absence of this message pair, this information must be obtained through some other means (such as CDROM).

The Initiate request message contains:

RRPID, an identifier to allow the cardholder to link this message to its response in case of several sessions

Language, the cardholder's language preference

LID_C and LID_M, the local ids that cardholder and merchant have assigned

Chall_C, cardholder generated challenge to prevent merchant replay response

BrandID, cardholder's chosen payment card brand

BIN, Bank Identification Number (first six digits of cardholders account number)

Thumbs, lists of Certificates, CRL and BrandCRLIdentifier thumbprints which the cardholder already has and so need not be transmitted.

The Initiate response message is signed by the merchant and contains:

TransIDs, transaction id

RRPIS, (as above)

Chall-C, the challenge from the cardholder

Chall-M, merchant generated challenge to ensure that freshness of cardholder's response can be verified

BrandCRLIdentifier, list of current CRLs for all Cas under a Brand CA

PEThumbs, thumbprint of payment gateway key-exchange certificate

Thumbs, copied from PInitReq.

The SET protocol allows this message pair to be omitted in non-interactiv environments, with the data provided in these messages by off-line mechanisms (such as CDROM) and the challenges omitted, with less guarantee of freshness of messages.

In the present invention, the system has other means of retrieving revocation information for merchant and other SET certificates. The important components of the above message pair, which are reflected in this implementation are:

transaction id

freshness of the next messages

identification of payment brand

It is the merchant's responsibility that the merchant system can handle a consumer which sets up several sessions at any one time. Therefore transaction id as gen rated by the consumer is no longer a SET issue. Identification of payment brand has already happened by the user's choice of the ASP payment option at the merchant site. Also, it is the merchants responsibility to ensure adequate confidentiality and integrity on the link between the cardholder's browser and the merchant's web site.

In the present invention, the (PInitReq, PInitRes) message pair is replaced by a merchant “wake-up” message to a front end of the hosted SET wallet at the ASP. The “wake-up” message is triggered by a positive authentication of a cardholder, and is a signed message containing:

merchant and cardholder identification

a challenge to ensure that freshness of the response can be checked (Chall-M above)

order information as necessary to complete the following message, PRes

a counter for this merchant (at the ASP), to prevent replay or message duplication resulting in multiple purchases. The ASP checks that the counter is the last counter for this merchant plus one, or otherwise rejects the transaction.

The “wake-up” call causes the hosted SET wallet to issue a Purchase request (PReq) message to the merchant.

PReq consists of two parts, OI, which is order information and PI, which is payment information. Both are encrypted and signed in such a way that the merchant can only decrypt OI and the acquirer only sees PI, but both can verify the integrity of the message in its entirety.

In ordinary SET it is allowable for a cardholder not to have a certificat. Messages from such cardholders are not signed. In the present invention, all cardholders will have certificates (held remotely at the ASP), and secure access to those via the usual authentication mechanism.

The hosted SET wallet module puts together a PReq message (PreqDualSigneddata) generating a new challenge Chall-C, as there were no (PInitReq, PinitRes) messages exchanged. Payment information data will come from the Registry at the ASP based on the cardholder information in the “Wake-up” message from the merchant.

The merchant receiving the PReq message performs a normal SET st p at this point, exactly as if dealing with the cardholder located (in terms of IP address) at the ASP. The merchant then tries to obtain payment authorisation for the transaction via their payment gateway. If successful, or before an answer has come back, depending on the merchant policy, the merchant generates a PRes message and sends it to the cardholder. This message contains, depending on its status, the completion code, authorisation code, capture code and credit code.

The SET wallet module receives and check the message and sends a non-SET message to the merchant, with information to pass on to the cardholder. An alternative option is to capture some of the data and transmit it via other means to the cardholder (e.g. monthly statement).

In addition to using the payment methods described above whereby a purchase at a merchant website is triggered by authenticating the consumer using the hardware token, the present invention enables token holders to use the system as a direct replacement for their existing credit cards at any merchant that already accepts credit cards online. This occurs as follows:

1. The consumer applies for a credit facility directly to the issuer of the hardware tokens. Assuming the consumer is approved for credit they are given a hardware token or informed that their current token is now activated for use as a credit card. They are given the following information:

(i) a standard 8 digit prefix to be used for all credit card purchases using the token; and,

(ii) an expiry date.

2. The consumer can then use the credit facility wherever they could have previously used any other conventional credit card by carrying out the following steps:

(i) they enter the standard 8 digit prefix in the first 8 digits of the 16 digit box used for credit card details;

(ii) they unlock the token and enter the one-time password generated by the token in the remaining digits;

(iii)they fill out the expiry date as given; and,

(iv) they enter their user name where they would normally put in a cardholders name.

3. The merchant then passes the transaction over to the acquirer in the normal way.

4. The acquirer recognises the number (first eight digits) and passes the transaction over to the token issuer as they would a normal transaction.

5. The issuer then passes the second eight digits (the one-time password) and the user name to the Vault for authentication. The Vault then translates the user and OTP into a specific customer and account and returns this to the issuer.

6. The issuer checks that the account is still valid and sufficient funds are available and then approves or rejects the transaction accordingly, informing the merchant and giving an authorisation code if appropriate.

In addition to the use described above, the card can be used as a proxy for a number of different credit cards. The user name and expiry remains constant all that varies is the 8 digit prefix. For example, with one hardware token a customer could have multiple eight digit prefixes, each one linking to a respective credit card account.

1. An authentication service for authenticating a consumer to a client using a remote authentication service provider that is adapted to respond to authentication requests from a plurality of different clients, in which the authentication service provider carries out the steps of:
receiving an authentication request, the authentication request including a consumer name and a unique consumer code;
accessing at least one authentication data store containing consumer data associated with the consumer name;
determining the validity of the unique consumer code in dependence on the consumer data; and,
transmitting an authentication reply to the client confirming whether or not the consumer has been authenticated.

2. An authentication service according to claim 1, in which the unique consumer code is a one-time password generated by a hardware token.

3. A computer program product comprising computer executable code for performing the method of claim 1 or 2.

4. An authentication engine for providing a remote authentication service for a plurality of different clients requiring authentication of consumers prior to completing a transaction or granting access to a service or application provided by the client, the authentication engine comprising:
a communications interface for accepting an authentication request from a client, the authentication request including a consumer name and a unique consumer code;
at least one authentication data store containing consumer data associated with the consumer name; and,
a processing system adapted for accessing the at least one authentication data store and determining the validity of the unique personal code in dependence on the consumer data, and for generating an authentication reply to the client confirming whether or not the consumer has been authenticated.

5. An authentication service according to claim 4, in which the unique consumer cod is a one-time password generated by a hardware tok n.

6. A method of authentication in which a consumer requests a transaction or access to a service or resource provided by a client, in which the client carries out the steps of:
obtaining a consumer name and a unique consumer code from the consumer,
transmitting an authentication request to a remote authentication service provider that is accessible by a number of different clients, the authentication request including the consumer name and the unique consumer code;
receiving an authentication reply from the remote authentication service provider identifying whether or not the consumer has been authenticated; and,
if the consumer is authenticated, proceeding with the transaction or providing the access or service requested by the consumer.

7. A method according to claim 6, in which the unique consumer code is a one-time password generated by a hardware token.

8. A payment authorisation service in which a client transmits a payment authorisation request in respect of a consumer transaction to a remote service provider adapted to respond to payment authorisation requests from a number of different clients, in which the remote service provider carries out the steps of:
receiving a payment authorisation request from a client, the payment authorisation request including a consumer and a unique consumer code;
accessing at least one data store containing consumer data associated with the consumer name and determining the validity of the unique consumer code in dependence on the consumer data, thereby authenticating the consumer; and,
executing a payment process to fulfil the payment authorisation request and thereby complete an authorised transaction.

9. A payment authorisation service according to claim 8, in which the uniqu consumer code is a one-time password generated by a hardware token.

10. A payment authorisation service according to claim 8 or 9, in which the manner in which payment authorisation is obtained is dependent on a payment protocol stipulated by the acquirer and/or issuer.

11. A payment authorisation service according to any of claims 8 to 10, which supports a plurality of different payment protocols through a number of different payment modules.

12. A payment authorisation service according to claim 11, which hosts a merchant POS payment module.

13. A computer program product comprises a computer executable code for performing the method of any of claims 8 to 12.

14. A payment authorisation engine for providing a hosted remote payment authorisation service for a plurality of different clients transacting with consumers, the payment authorisation engine comprising:
a communications interface for receiving a payment authorisation request from a client, the payment authorisation request including a consumer name and a uniqu consumer code;
a number of data stores containing consumer data, including details of consumer payment cards; and
a processing system including a number of payment modules that enabl authorised payments according to a predetermined protocol, the processing system being adapted for accessing at least one data store containing consumer data associated with the consumer name and determining the validity of the uniqu consumer code, thereby authenticating the consumer, and execute a payment process using a selected payment module to fulfil the payment authorisation request and thereby complete an authorised transaction.

15. A payment authorisation engine according to claim 14, in which the unique consumer code is a one-time password generated by a hardware token.

16. A payment authorisation engine according to claim 14 or 15, in which the manner in which payment authorisation is obtained is dependent on a payment protocol stipulated by the acquirer and/or issuer.

17. A payment authorisation engine according to any of claims 14 to 16, which supports a plurality of different payment protocols through a number of different payment modules.

18. A payment authorisation engine according to claim 17, which hosts a merchant POS payment module.

19. A payment authorisation engine according to any of claims 14 to 18, further comprising a first database that contains data associated with respective consumer names to allow a consumer to be authenticated.

20. A payment authorisation engine according to any of claims 14 to 19, further comprising a second database that contains credit and/or debit card details associated with respective consumers.
